(19) United States
(12) Patent Application Publication
(10) Pub. No.: US 2022/0415360 A1
(43) Pub. Date: Dec. 29, 2022

(54) METHOD AND APPARATUS FOR GENERATING SYNOPSIS VIDEO AND SERVER

(71) Applicants: ALIBABA GROUP HOLDING LIMITED, George Town (KY); NANYANG TECHNOLOGICAL UNIVERSITY, Singapore (SG)

(72) Inventors: Yi DONG, Hangzhou (CN); Chang LIU, Hangzhou (CN); Zhiqi SHEN, Hangzhou (CN); Han YU, Hangzhou (CN); Zhanning GAO, Hangzhou (CN); Pan WANG, Hangzhou (CN); Peiran REN, Hangzhou (CN)

(21) Appl. No.: 17/929,214

(22) Filed: Sep. 1, 2022

Related U.S. Application Data
(63) Continuation of application No. PCT/CN2020/079461, filed on Mar. 16, 2020.

(51) Int. Cl. G11B 27/031; H04N 5/262; G06V 10/40

(52) U.S. Cl. CPC G11B 27/031; H04N 5/2625; G06V 10/40

(57) ABSTRACT

A method for generating a synopsis video includes acquiring a target video and parameter data related to editing of the target video, wherein the parameter data comprises at least a duration parameter of a synopsis video of the target video; extracting a plurality of pieces of image data from the target video, and determining an image label of the image data, wherein the image label comprises at least a visual-type label; and determining a type of the target video, and establishing a target editing model for the target video according to the type of the target video, the duration parameter, and a plurality of preset editing technique submodels; and editing the target video according to the image label of the image data in the target video by using the target editing model to obtain the synopsis video of the target video

### CROSS-REFERENCE TO RELATED APPLICATIONS

The disclosure claims the benefits of priority to PCT Application No. PCT/CN2020/079461, filed on Mar. 16, 2020, which is incorporated herein by reference in its entirety.

### TECHNICAL FIELD

The present disclosure relates to the field of Internet technologies, and in particular, to a method and an apparatus for generating a synopsis video, and a server.

### BACKGROUND

With the rise and popularity of short videos in recent years, in some application scenarios, synopsis videos that have been edited and have relatively short durations are often more likely to be clicked and viewed by a user and achieve better placement effects when compared to original videos that have relatively long durations.

### SUMMARY OF THE DISCLOSURE

The present disclosure provides a method and an apparatus for generating a synopsis video and a server, so that a target video can be efficiently edited to generate a synopsis video that has accurate content and is more attractive to a user.

The method and apparatus for generating a synopsis video and the server provided in the present disclosure are implemented as follows.

A method for generating a synopsis video includes: acquiring a target video and parameter data related to editing of the target video, wherein the parameter data comprises at least a duration parameter of a synopsis video of the target video; extracting a plurality of pieces of image data from the target video, and determining an image label of the image data, wherein the image label comprises at least a visual-type label; and determining a type of the target video, and establishing a target editing model for the target video according to the type of the target video, the duration parameter, and a plurality of preset editing technique submodels; and editing the target video according to the image label of the image data in the target video by using the target editing model to obtain the synopsis video of the target video.

An apparatus for generating a synopsis video, the apparatus includes: a memory configured to store instruction, and one or more processors configured to execute the instructions to cause the apparatus to perform: acquiring a target video and parameter data related to editing of the target video, wherein the parameter data comprises at least a duration parameter of a synopsis video of the target video; extracting a plurality of pieces of image data from the target video, and determining an image label of each piece of the plurality of pieces of the image data, wherein the image label comprises at least a visual-type label; determining a type of the target video; establishing a target editing model for the target video according to the type of the target video, the duration parameter, and a plurality of preset editing technique submodels; and editing the target video according to the image label of the image data in the target video by using the target editing model to obtain the synopsis video of the target video.

A computer-readable storage medium storing a set of computer instructions that are executable by one or more processors of an apparatus to cause the apparatus to perform a method. The method includes: acquiring a target video and parameter data related to editing of the target video, wherein the parameter data comprises at least a duration parameter of a synopsis video of the target video; extracting a plurality of pieces of image data from the target video, and determining an image label of the image data, wherein the image label comprises at least a visual-type label; and determining a type of the target video, and establishing a target editing model for the target video according to the type of the target video, the duration parameter, and a plurality of preset editing technique submodels; and editing the target video according to the image label of the image data in the target video by using the target editing model to obtain the synopsis video of the target video.

### BRIEF DESCRIPTION OF THE DRAWINGS

To describe the embodiments of the present disclosure more clearly, the following briefly describes the accompanying drawings required for the embodiments. The accompanying drawings in the following description show merely some embodiments recorded in this disclosure, and a person of ordinary skill in the art may still derive other drawings from these accompanying drawings without creative efforts.

FIG. 1 is a schematic diagram illustrating a system structure to which a method for generating a synopsis video is applied, according to some embodiments of the present disclosure.

FIG. 2 is a schematic diagram illustrating a scenario example in which a method for generating a synopsis video is applied, according to some embodiments of the present disclosure.

FIG. 3 is a schematic diagram illustrating a scenario example in which a method for generating a synopsis video is applied, according to some embodiments of the present disclosure.

FIG. 4 is a schematic diagram illustrating a scenario example in which a method for generating a synopsis video is applied, according to some embodiments of the present disclosure.

FIG. 5 is a schematic flowchart of a method for generating a synopsis video, according to some embodiments of the present disclosure.

FIG. 6 is a schematic flowchart of a method for generating a synopsis video, according to some embodiments of the present disclosure.

FIG. 7 is a schematic flowchart of a method for generating a synopsis video, according to some embodiments of the present disclosure.

FIG. 8 is a schematic structural diagram of a server, according to some embodiments of the present disclosure.

FIG. 9 is a schematic structural diagram of an apparatus for generating a synopsis video, according to some embodiments of the present disclosure.

### DETAILED DESCRIPTION

For a person skilled in the art to better understand the technical solution in the present disclosure, the technical solutions in the embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The embodiments of the present disclosure provide a method and an apparatus for generating a synopsis video and a server. A plurality of pieces of image data are first extracted from a target video, and an image label (such as a visual-type label) of each piece of image data is determined respectively. Then, a target editing model for the target video is established according to a type of the target video and a duration parameter of a synopsis video of the target video and in combination with a plurality of preset editing technique submodels. The target editing model may then be used to efficiently edit the target video in a targeted manner according to the image label of the image data in the target video to generate the synopsis video. Therefore, a synopsis video that conforms to an original target video and has accurate content, would be highly attractive to users.

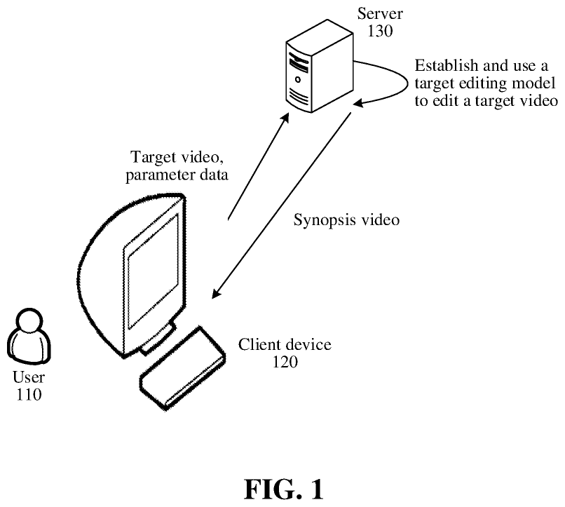

Embodiments of the present disclosure provide a method for generating a synopsis video. The method is specifically applicable to a system architecture including a server and a client device. For details, reference may be made to FIG. 1.

In this example, a user 110 may use the client device 120 to input an original video that is to be edited and has a relatively long duration as a target video, and use the client device 120 to input and set parameter data related to editing of the target video. The parameter data includes at least a duration parameter of a synopsis video that is obtained by editing the target video and has a relatively short duration. The client device 120 acquires the target video and the parameter data related to the editing of the target video, and sends the target video and the parameter data to the server 130.

The server 130 acquires the target video and the parameter data related to the editing of the target video. During specific implementation, a plurality of pieces of image data from the target video are extracted, and an image label of each piece of the image data is determined. The image label may include a visual-type label and/or a structure-type label. A type of the target video is determined. A target editing model for the target video is established according to the type of the target video, the duration parameter, and a plurality of preset editing technique submodels. The target video is edited according to the image label of the image data in the target video by using the target editing model to obtain the synopsis video of the target video. The server 130 then feeds back the synopsis video of the target video obtained by editing to the user through the client device. Therefore, the server 130 can serve the user more efficiently, and automatically edit the target video to generate a synopsis video that has accurate content and is highly attractive.

In this example, the server 130 may specifically include a back-end server responsible for data processing, where the back-end server 130 is applied to a service data processing platform side and can implement functions such as data transmission and data processing. Specifically, the server 130 may be, for example, an electronic device that has a data operation function, a data storage function, and a network interaction function. Alternatively, the server 130 may be a software program that is run in the electronic device and provides support for data processing and storage and network interaction. In this example, a quantity of servers is not specifically limited. The server may be specifically one server or may be several servers or a server cluster formed by a plurality of servers.

In this example, the client device may specifically include a front-end device that is applied to a user side and can implement functions such as data input and data transmission. Specifically, the client device may be, for example, a desktop computer, a tablet computer, a notebook computer, a smartphone, a digital assistant, a smart wearable device, or the like used by the user. Alternatively, the client device may be a software application executable in the electronic device. For example, the client device may be an APP run on a smartphone.

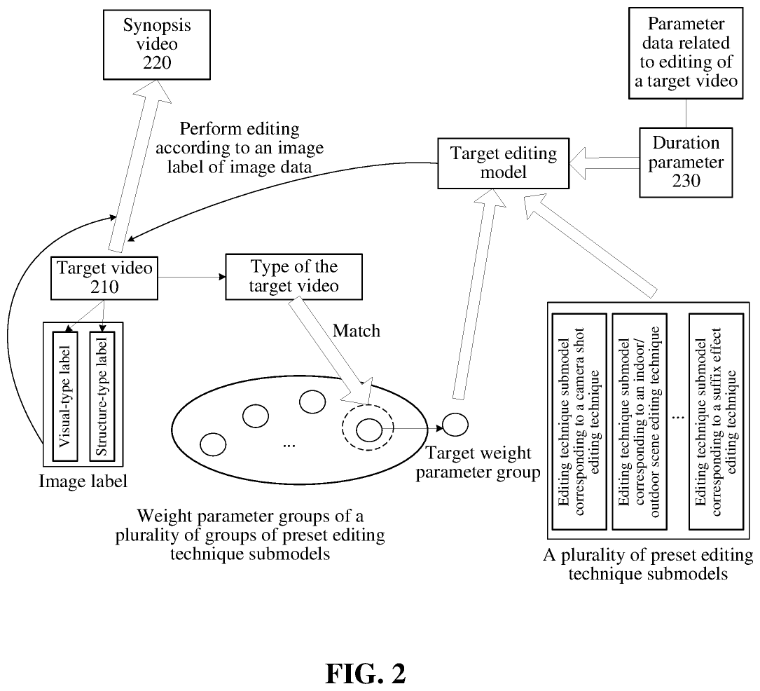

In a specific scenario example, reference may be made to FIG. 2. A merchant A on a shopping platform may use the method for generating a synopsis video provided in the embodiments of the present disclosure to edit a marketing promotion video of design-I sneakers that the merchant sells on the shopping platform into a synopsis video that has a relatively short duration but accurate content summary and is highly attractive to a user.

In this scenario example, during specific implementation, the merchant A may use a notebook computer as a client device and use the client device to input the marketing promotion video of the design-I sneakers that needs to be edited and has a relatively long duration as a target video.

In this scenario example, with no editing skills, the merchant A only needs to set one type of parameter data, that is, a duration parameter, for a synopsis video 220 of the target video 210 according to prompts from the client device in combination with requirements of the merchant A to complete a setting operation.

For example, the merchant A may simply input “60 seconds” in an input box of a duration parameter of a synopsis video on a parameter data setting interface displayed by the client device for use as a duration parameter 230 for a synopsis video of the target video that needs to be obtained through editing, to complete a setting operation of parameter data related to editing of the target video.

The client device receives and responds to the operation of the merchant A to generate an editing request for the target video, and sends the editing request, the target video inputted by the merchant A, and the parameter data to a server in a wired or wireless manner, which is responsible for video editing in a data processing system of the shopping platform.

The server receives the editing request, and acquires the target video 210 and the duration parameter 230 set by the merchant A. The server may then edit the target video 210 for the merchant A in response to the editing request, to generate a synopsis video that meets the requirements of the merchant A and has relatively high quality.

In this scenario example, during specific implementation, the server may first downsample the target video to extract a plurality of pieces of image data from the target video. The downsampling can avoid one-to-one extraction and subsequent procession on all the image data in the target video, thereby reducing the data processing amount of the server and improving the overall processing efficiency.

Specifically, the server may sample the target video every one second to extract a plurality of pieces of image data from the target video. Each of the plurality of pieces of image data corresponds to one time point. An interval between time points corresponding to adjacent image data is one second. Certainly, the listed manner of extracting image data through downsampling is only a schematic description. During specific implementation, according to a specific case, another appropriate manner may be used to extract a plurality of pieces of image data from the target video.

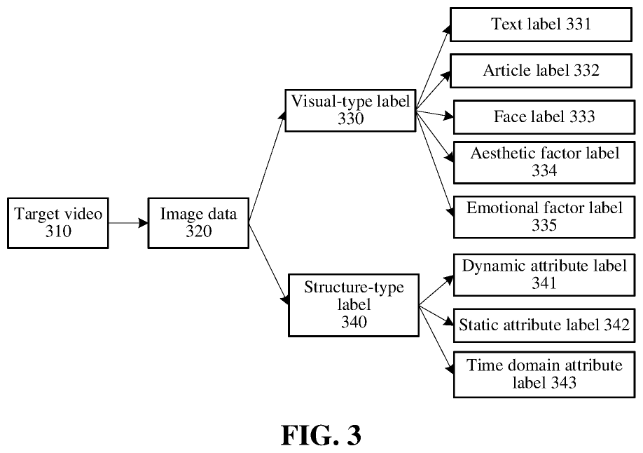

After extracting the plurality of pieces of image data from the target video, the server further determines an image label of each piece of image data in the plurality of image data. For details, reference may be made to FIG. 3.

The image label may be specifically understood as label data used for representing a type of attribute feature in the image data 320. Specifically, according to a dimension type based on which an attribute feature is determined, the image label may specifically include a visual-type label 330 and/or a structure-type label 340. These are the two major types of labels obtained based on different dimensions.

The visual-type label 330 may specifically include label data used for representing an attribute feature that is determined by processing an image of a single piece of image data 320 based on a visual dimension. Such label data is related to information such as content or emotion included in the target video 310, and is attractive to a user.

Further, the visual-type label 330 may specifically include at least one of the following: a text label 331, an article label 332, a face label 334, an aesthetic factor label 335, an emotional factor label 336, and the like.

The text label 331 may specifically include a label used for representing a text feature in the image data. The article label 332 may specifically include a label used for representing an article feature in the image data 320. The face label 333 may specifically include a label used for representing a face feature of a human object in the image data. The aesthetic factor label 334 may specifically include a label used for representing an aesthetic feature of a picture in the image data. The emotional factor label 335 may specifically include a label used for representing an emotional or interest feature related to content in the image data 320.

It needs to be noted that the picture aesthetic of the image data has an influence on whether a user is willing to click and view the target video. For example, if the picture of a video is beautiful and pleasing, the video is relatively attractive to a user, and the user is usually more willing to click and view the video and accept information conveyed by the video.

In addition, the emotion and interest related or implied in the content of the image data also have an influence on whether a user is willing to click and view the target video. For example, if the content of a video can better interest a user or the emotion implied in the content of a video better resonates with a user, the video is relatively attractive to the user, and the user is more willing to click and view the video and accept information conveyed by the video.

Therefore, in this example, it is proposed that a visual-type label 330 such as an aesthetic factor label 334 and/or an emotional factor label 335 in image data may be determined and used as a basis for determining on a mental level whether the image data of the video is attractive to a user or excites the attention of a user.

Certainly, the above listed visual-type label 330 is only a schematic description. During specific implementation, according to a specific application scenario and processing requirement, a label of another type different from the above listed label may be introduced as a visual-type label. This is not limited in the present disclosure.

The structure-type label 340 may specifically include label data used for representing an attribute feature that is determined by associating a feature of the image data 320 and a feature of another piece of image data 320 in the target video 310 based on a structural dimension. Such label data is related to a structure and layout of the target video 310, and is attractive to a user.

Further, the above-mentioned structure-type label 340 may specifically include at least one of the following: a dynamic attribute label 341, a static attribute label 342, a time domain attribute label 343, and the like.

The dynamic attribute label 341 may specifically include a label used for representing a dynamic feature of a target object (for example, a person or an article in the image data) in the image data. The static attribute label 342 may specifically include a label used for representing a static feature of a target object in the image data. The time domain attribute label 343 may specifically include a label used for representing, relative to the entire target video, a corresponding time domain feature of the image data. The time domain may specifically include a head time domain, an intermediate time domain, a tail time domain, and the like.

It should be noted that for a maker of a target video, during specific making of the target video, the maker usually makes some structural layout. For example, some pictures that tend to attract the attention of a user may be arranged in a head time domain (for example, a beginning position of the video) of the target video; subject content that the target video is to convey may be arranged in an intermediate time domain (for example, an intermediate position of the video) of the target video; and key information (such as a purchase link and a coupon of a commodity) that a user is expected to remember in the target video is arranged in a tail time domain (for example, an end position of the video) of the target video. Therefore, the time domain attribute label of the image data may be determined and used as a basis for determining whether the image data carries relatively important content data in the target video, based on a making layout and a narrative level of the video.

In addition, during the making of the target video, the maker further designs some actions or states of a target object to convey relatively important content information to a user who is watching the video. Therefore, the dynamic attribute label and/or the static attribute label of the image data may be determined and used as a basis for determining more precisely whether the image data carries relatively important content data in the target video.

Certainly, the listed structure-type label is only a schematic description. During specific implementation, according to a specific application scenario and processing requirement, a label of another type different from the above listed label may be introduced as a structure-type label. This is not limited in the present disclosure.

In this scenario example, for different types of image labels of image data, the server may use corresponding determination manners for determination.

Specifically, for the text label, the server may first extract an image feature related to a text (for example, a character, a letter, a number, or a symbol that appears in the image data) from the image data; and then perform recognition and matching on the image feature related to a text, and determine a corresponding text label according to a result of the recognition and matching.

For the article label, the server may first extract an image feature used for representing an article from the image data; and then perform recognition and matching on the image feature representing an article, and determine a corresponding article label according to a result of the recognition and matching.

For the face label, the server may first extract image data used for representing a person from the image data; then further extract image data representing a human face area from the image data representing a person; and may perform feature extraction on the image data representing a human face area, and determine a corresponding face label according to the extracted face feature.

For the aesthetic factor label, the server may invoke a preset aesthetic scoring model to process the image data to obtain a corresponding aesthetic score, where the aesthetic score is used for representing attractiveness generated to a user from the image data based on picture aesthetic; and then determine the aesthetic factor label of the image data according to the aesthetic score. Specifically, for example, the server may use the preset aesthetic scoring model to determine an aesthetic score of the image data; and then compare the aesthetic score with a preset aesthetic score threshold, and if the aesthetic score is greater than the preset aesthetic score threshold, determine that the image data generates relatively high attractiveness to a user based on picture aesthetic, so that the aesthetic factor label of the image data may be determined as a strong aesthetic factor.

The preset aesthetic scoring model may specifically include a scoring model established by training and learning in advance a lot of image data labeled with aesthetic scores.

For the emotional factor label, the server may invoke a preset emotional scoring model to process the image data to obtain a corresponding emotional score, where the emotional score is used for representing attractiveness generated to a user from the image data based on emotion and interest; and then determine the emotional factor label of the image data according to the emotional score. Specifically, for example, the server may use the preset emotional scoring model to determine an emotional score of the image data; and then compare the emotional score with a preset emotional score threshold. If the emotional score is greater than the preset emotional score threshold, it indicates that the image data can generate relatively high attractiveness to a user based on emotion, interest or the like related to content, so that the emotional factor label of the image data may be determined as a strong emotional factor.

The preset emotional scoring model may specifically include a scoring model established by training and learning in advance a lot of image data labeled with emotional scores.

For the dynamic attribute label, the server may first acquire image data adjacent before and after the image data for which a label is to be determined as reference data; then acquire a pixel indicating a target object (for example, a person in the image data) in the image data as an object pixel, and acquire a pixel indicating the target object in the reference data as a reference pixel; further compare the object pixel with the reference pixel to determine an action of the target object (for example, a gesture made by the target object in the image data); and then determine the dynamic attribute label of the image data according to the action of the target object. Specifically, for example, the server may use a previous frame image data and a next frame image data of current image data as reference data; further respectively acquire a pixel of a human object in the current image data as an object pixel and a pixel corresponding to a person in the reference data as a reference pixel; determine an action of the human object in the current image data by comparing a difference between the object pixel and the reference pixel to; then match and compare the action of the human object in the current image data with preset actions representing different meanings or moods, determine a meaning or mood represented by the action in the current image data according to a result of the matching and comparison, and may further determine a corresponding dynamic attribute label according to the meaning or mood.

The determination of a static attribute label is similar to the determination of a dynamic attribute label. During specific implementation, image data adjacent before and after the current image data may be acquired as reference data; a pixel indicating a target object in the image data is acquired as an object pixel, and a pixel indicating the target object in the reference data is acquired as a reference pixel; the object pixel is compared with the reference pixel to determine a still state of the target object (for example, a sitting gesture of the target object in the image data); and then the static attribute label of the image data is determined according to the still state of the target object.

For the time domain attribute label, the server may first determine a corresponding time point (for example, 01:02) of the image data in the target video. A time domain corresponding to the image data is then determined according to the time point of the image data in the target video and a total duration of the target video. The time domain may specifically include a head time domain, a tail time domain, an intermediate time domain, and the like. The time domain attribute label of the image data is determined according to the time domain corresponding to the image data. Specifically, for example, the server may first determine that a time point corresponding to the current image data is 00:10, that is, the 10th second after the target video is started; determine that a total duration of the target video is 300 seconds; then may calculate, according to the time point corresponding to the image data and the total duration of the target video, that a duration ratio is 1/30, where the duration ratio is a ratio of a duration between the start of the target video and the time point corresponding to the image data to the total duration of the target video; and then determine, according to the duration ratio and a preset time domain division rule, that the time point corresponding to the image data is located in the first 10% time domain of the total duration of the target video, and determine that the time domain corresponding to the image data is the head time domain, and the time domain attribute label of the image data is determined as the head time domain.

In the foregoing manner, the server may process each piece of image data in the plurality of pieces of image data respectively, and determine one or more image labels of different types, corresponding to each piece of image data.

In addition, the server may further use image recognition, semantic recognition, and the like to determine that a commodity object that the target video is to promote is sneakers, and it may be determined that the type of the target video is a sneakers type.

Further, the server may search and match weight parameter groups of a plurality of groups of preset editing technique submodels according to the type of the target video. A weight parameter group of a preset editing technique submodel matching the sneakers type is found from the weight parameter groups of the plurality of groups of preset editing technique submodels as a target weight parameter group.

The preset editing technique submodel may specifically include a function model that can correspondingly edit a video based on an editing characteristic of an editing technique.

Before specific implementation, the server may learn in advance a plurality of editing techniques of different types, to establish and obtain a plurality of different preset editing technique submodels. Each editing technique submodel in the plurality of preset editing technique submodels corresponds to one editing technique.

Specifically, the server may learn in advance editing techniques of different types to determine editing characteristics of editing techniques of different types; then establish editing rules for different editing techniques according to the editing characteristics of the editing techniques of different types; and generate an editing technique submodel corresponding to an editing technique, according to the editing rules, as a preset editing technique submodel.

The preset editing technique submodels may specifically include at least one of the following: an editing technique submodel corresponding to a camera shot editing technique, an editing technique submodel corresponding to an indoor/outdoor scene editing technique, an editing technique submodel corresponding to an emotional fluctuation editing technique, an editing technique submodel corresponding to a dynamic editing technique, an editing technique submodel corresponding to a recency effect editing technique, an editing technique submodel corresponding to a primacy effect editing technique, an editing technique submodel corresponding to a suffix effect editing technique, and the like. Certainly, it should be noted that the listed preset editing technique submodel is only a schematic description. During specific implementation, according to a specific application scenario and processing requirement, an editing technique submodel of another type different from the above listed preset editing technique submodel may be introduced. This is not limited in the present disclosure.

In this scenario example, it is considered that an experienced editor usually combines a plurality of different editing techniques in a process for editing a high-quality video. In addition, for videos of different types, corresponding knowledge fields and application scenarios as well as mood responses and interests of a user during watching may differ greatly. Therefore, during editing of videos of different types, types of combined editing techniques and a specific combination manner also differ correspondingly.

For example, in a marketing promotion-type video, a hotel-type video focuses more on the decorations and facilities of rooms of a hotel and the comfort experience of a user staying in the hotel. Therefore, during editing, a type-A editing technique is more likely to be used during editing, a type-B editing technique is used together, and a type-C editing technique is never used. A movie video focuses more on the narrative of movie content and a feature such as bringing intense visual impact to a user. Therefore, during editing, a type-D editing technique and a type-E editing technique are more likely to be used during editing, and a type-H editing technique is used together.

Based on the foregoing considerations, the server may learn in advance editing of a large number of videos of different types. The server learns types of editing techniques used during editing of videos of different types and a combination manner of used editing techniques, so that weight parameter groups of a plurality of groups of preset editing technique submodels corresponding to editing of videos of different types may be established and obtained.

A weight parameter group of each group of preset editing technique submodels in the weight parameter groups of the plurality of groups of preset editing technique submodels may correspond to editing of videos of one type.

Specifically, the learning of video editing of a commodity promotion scenario is used as an example. The server may first acquire a plurality of original videos of different types such as a clothing type, a food type, a cosmetics type, and a sneakers type as sample videos. In addition, a synopsis video obtained after editing a sample video is acquired as a sample synopsis video. The sample video and the sample synopsis video of the sample video are combined into one piece of sample data, so that a plurality of pieces of sample data corresponding to the plurality of videos of different types may be obtained. Next, the sample data may be labeled according to a preset rule, respectively.

During specific labeling, the labeling of one piece of sample data is used as an example. A type of a sample video in the sample data may be first labeled. Further, the sample video in the sample data may be compared with the image data in the sample synopsis video. An image label of image data included in the sample synopsis video and an editing technique type corresponding to the sample synopsis video are determined and labeled from the sample data. Labeled sample data are obtained after the labeling completed.

Further, weight parameter groups of a plurality of groups of preset editing technique submodels corresponding to editing and matching of the videos of a plurality of types are determined, by learning the labeled sample data.

Specifically, a maximum margin learning framework may be used as a learning model. The weight parameter groups of a plurality of groups of preset editing technique submodels corresponding to editing of videos of a plurality of types can be efficiently and accurately determined, by keeping learning the inputted labeled sample data using the learning model. Certainly, it should be noted that the listed maximum margin learning framework is only a schematic description. During specific implementation, another appropriate model structure may be used as a learning model to determine the weight parameter groups of a plurality of groups of preset editing technique submodels.

In this scenario example, after determining that the type of the target video is a sneakers type, the server may determine a weight parameter group of a group of preset editing technique submodels matching and corresponding to the sneakers type may be determined from the weight parameter groups of the plurality of groups of preset editing technique submodels as a target weight parameter group.

Further, the server may determine preset weights of the plurality of preset editing technique submodels according to a target weight parameter group; then combine a plurality of preset editing technique submodels according to the preset weights of the plurality of preset editing technique submodels; and set a time constraint of an optimized target function in a combined model according to a duration parameter, so that an editing submodel that is suitable for performing relatively high-quality editing on the target video, that is, a sneakers type video, may be established and obtained as the target editing model.

Further, the server may run the target editing model to specifically edit the target video. When editing the target video during specific running, the target editing model may separately determine, according to an image label of image data in the target video, whether the image data in the target video is to be deleted or kept; and splice the kept image data to obtain a synopsis video with a relatively short duration.

In the editing process, a plurality of editing techniques suitable for a type of the target video are combined in a targeted manner based on content narrative and the psychology of a user (or referred to as a target audience of a video), and dimensions of two different types, that is, content vision and a layout structure, are integrated to automatically and efficiently edit the target video in a target manner, so that a synopsis video that conforms to an original target video, has accurate content summary, and is highly attractive to a user can be obtained. For example, a synopsis video obtained after the server edits the marketing promotion video of the design-I sneakers in the above-described editing manner not only can accurately summarize content, such as style, function, and price of the design-I sneakers that a user cares about, but also can emphasize characteristics of the design-I sneakers different from other sneakers of the same type, with a good picture aesthetic. The entire video is likely to resonate with a user and can generate relatively high attractiveness to a user based on emotion.

After generating the synopsis video, the server may send the synopsis video to the client device of the merchant A in a wired or wireless manner.

After receiving the synopsis video through the client device, the merchant A may place the synopsis video to a short video platform or a promotion video page of the shopping platform. A user is more willing to watch and view the video after seeing the synopsis video and becomes greatly interested in the design-I sneakers promoted in the video, so that a better promotion placement effect is achieved, thereby helping to increase a closing ratio that the merchant A sells the design-I sneakers on the shopping platform.

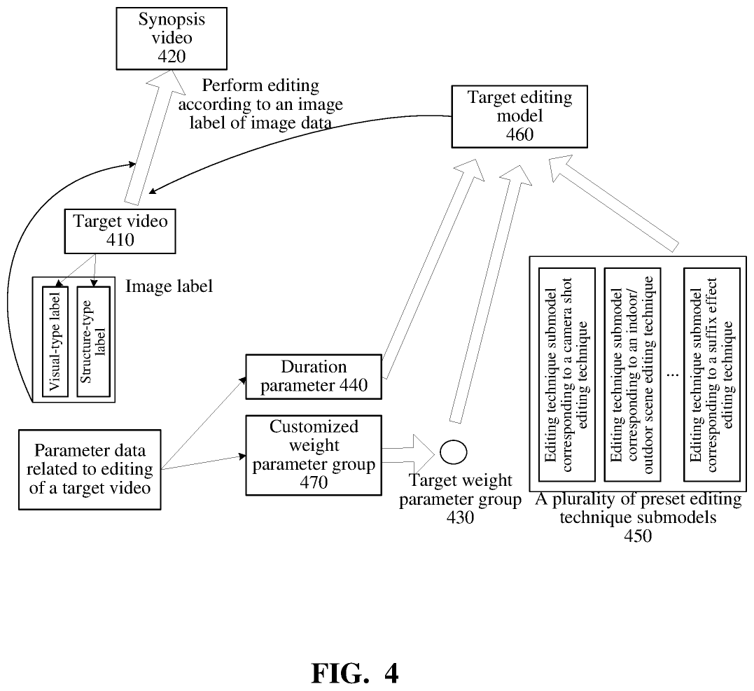

In another specific scenario example, referring to FIG. 4, for a user with certain editing knowledge to customize editing of a target video according to preferences and requirements of the user, an input box of a customized weight parameter group may be further included in the parameter data setting interface displayed by the client device, to support that a user customizes a weight parameter of each preset editing technique submodel in the plurality of preset editing technique submodels.

In addition, to reduce the data processing amount of the server, a type parameter input box may be further included in the parameter data setting interface, to support that a user inputs a video type of a target video to be edited. In this way, without consuming a processing resource and a processing time, the server may recognize and determine a video type of a target video, so that the video type of the target video may be directly and quickly determined according to the type parameter inputted by a user in the parameter data setting interface.

Specifically, for example, a merchant B with certain editing knowledge and editing experience intends to edit, according to preferences of the merchant B, a marketing promotion video of design-II clothes that the merchant B sells on the shopping platform into a synopsis video with a duration of only 30 seconds.

During specific implementation, the merchant B may use a smartphone as a client device and use the smartphone to upload the marketing promotion video of design-II clothes to be edited as a target video.

Further, the merchant B may input “30 seconds” in an input box of a duration parameter of a synopsis video 420 on a parameter data setting interface displayed by the smartphone to set the duration parameter. The merchant B inputs “a clothing type” in the type parameter input box on the parameter data setting interface. The setting operation is completed.

The smartphone may respond to the operation of the merchant B to generate a corresponding editing request, and send the editing request, the target video 410 inputted by the merchant B, and the parameter data together to the server. After receiving the editing request, the server may directly determine, according to the type parameter included in the parameter data, that the type of the target video is the clothing type, and does not need to additionally perform recognition to determine the video type of the target video. A target weight parameter group 430 matching the clothing type is then determined from the weight parameter groups of the plurality of groups of preset editing technique submodels. According to the target weight parameter group 430 and the duration parameter 440 inputted by the merchant B, a plurality of preset editing technique submodels 450 are combined to establish and obtain a target editing model for the marketing promotion video of the design-II clothes inputted by the merchant B. The target video is then edited by using the target editing model 460 to obtain a synopsis video with relatively high quality, and the synopsis video 420 is fed back to the merchant B. Therefore, the data processing amount of the server can be effectively reduced, thereby improving the overall editing efficiency.

In addition, after setting the duration parameter 440, the merchant B may input a customized weight parameter group 470 in an input box of a customized weight parameter group on the parameter data setting interface according to preferences and requirements of the merchant B. For example, the merchant B personally prefers to use a camera shot editing technique, an indoor/outdoor scene editing technique, and an emotional fluctuation editing technique more often, use a dynamic editing technique and a recency effect editing technique less often, and is not willing to use a primacy effect editing technique and a suffix effect editing technique. In this case, the merchant B may input a customized weight parameter group in the input box of the customized weight parameter group on the parameter data setting interface displayed by the smartphone to complete the setting operation, the customized weight parameter group being as follows: a weight parameter of the editing technique submodel corresponding to the camera shot editing technique is 0.3, a weight parameter of the editing technique submodel corresponding to the indoor/outdoor scene editing technique is 0.3, and a weight parameter of the editing technique submodel corresponding to the emotional fluctuation editing technique is 0.3; a weight parameter of the editing technique submodel corresponding to the dynamic editing technique is 0.05, and a weight parameter of the editing technique submodel corresponding to the recency effect editing technique is 0.05; and a weight parameter of the editing technique submodel corresponding to the primacy effect editing technique is 0, and a weight parameter of the editing technique submodel corresponding to the suffix effect editing technique is 0.

Correspondingly, the smartphone may respond to the operation of the merchant B to generate a corresponding editing request, and send the editing request, the target video inputted by the merchant B, and the parameter data together to the server. After receiving the editing request, the server may extract, from the parameter data, the customized weight parameter group set by the merchant B, so that instead of matching and determining the target weight parameter group from the parameter groups of the plurality of groups of preset editing technique submodels, the customized weight parameter group may be directly determined as the target weight parameter group. According to the target weight parameter group and the duration parameter inputted by the merchant B, a plurality of preset editing technique submodels are then combined to establish and obtain a target editing model for the marketing promotion video of the design-II clothes inputted by the merchant B. The target video is then edited by using the target editing model to obtain a synopsis video that satisfies the preferences and requirements of the merchant B, and the synopsis video is fed back to the merchant B. Therefore, while the data processing amount of the server is reduced and the overall editing efficiency is improved, customized editing requirements of a user can be satisfied to generate a synopsis video that satisfies customization requirements of the user, thereby improving the use experience.

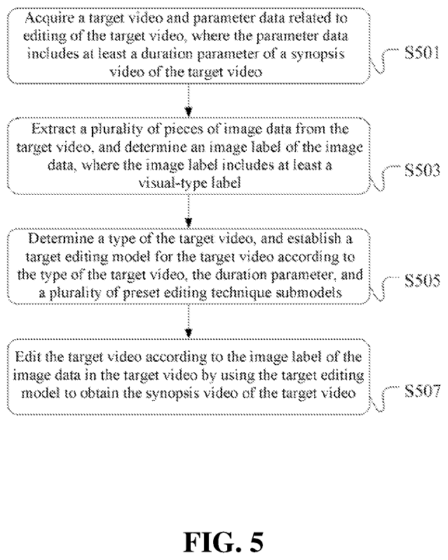

Referring to FIG. 5, embodiments of the present disclosure provide a method for generating a synopsis video. The method is specifically applied to a server side. During specific implementation, the method may include the following steps.

At S501, a target video and parameter data related to editing of the target video are acquired. The parameter data includes at least a duration parameter of a synopsis video of the target video.

In some embodiments, the target video may be understood as an original video to be edited. Specifically, according to a different application scenario of the target video, the target video may specifically include a video for a commodity promotion scenario, for example, an advertisement promotion video of a commodity. The target video may include a video of a promotion scenario for a city, a scenic spot, or the like, for example, a tourism promotion video. The target video may include an introduction video for a company organization, business services, or the like, for example, a service introduction video of a company.

A target video of an application scenario may be further classified into a plurality of videos of different types. For example, for a video for a commodity promotion scenario, according to different types of commodities that a target video is to promote, the target video may further include a plurality of different types such as a clothing type, a food type, and a cosmetics type. Certainly, the above listed types of the target video are only a schematic description. During specific implementation, according to a specific application scenario of a target product, the target video may include another type. For example, the target video may include a toy type, a home decoration type, a book type, and the like. This is not limited in the present disclosure.

In some embodiments, the parameter data related to the editing of the target video may include at least a duration parameter of a synopsis video of the target video. The synopsis video may be specifically understood as a video obtained after editing the target video. The target video usually has a longer duration than the synopsis video.

A specific value of the above-mentioned duration parameter may be flexibly set according to a specific case and a specific requirement of a user. For example, the user wants to place the synopsis video to a short video platform. A short video to be placed on the short video platform needs to have a duration within 25 seconds. In this case, the duration parameter may be set to 25 seconds.

In some embodiments, the above-mentioned parameter data may further include a type parameter or the like of the target video. The type parameter of the target video may be used for representing a type of the target video. During specific implementation, according to a specific case and a processing requirement, the parameter data may further include other data related to the editing of the target video in addition to the above listed data.

In some embodiments, during specific implementation, the acquiring a target video may include: receiving a to-be-edited video uploaded by the user through a client device or the like as the target video.

In some embodiments, during specific implementation, the acquiring parameter data related to editing of the target video may include: displaying a related parameter data setting interface to the user; receiving data inputted and set by the user in the parameter data setting interface as the parameter data. The acquiring parameter data related to editing of the target video may further include: displaying a plurality of pieces of recommended parameter data in the parameter data setting interface for selection by the user; and determining recommended parameter data chosen by the user as the parameter data.

At S503, a plurality of pieces of image data from the target video are extracted, and an image label of the image data is determined. The image label includes at least a visual-type label.

In some embodiments, the image data may specifically include one frame of image extracted from the target video.

In some embodiments, the image label may be specifically understood as label data used for representing a type of attribute feature in the image data. Specifically, according to a dimension type based on which an attribute feature is determined, the image label may specifically include a visual-type label. The visual-type label may specifically include a label used for representing an attribute feature generating attractiveness to a user based on a visual dimension in the image data.

In some embodiments, the image label may specifically further include a structure-type label. The structure-type label may specifically include a label used for representing an attribute feature generating attractiveness to a user based on a structural dimension in the image data.

In some embodiments, during specific implementation, the visual-type label may be only separately determined and used as the image label of the image data. The structure-type label may be also only separately determined and used as the image label of the image data.

In some embodiments, during specific implementation, the visual-type label and the structure-type label of the image data may be simultaneously determined and used as image labels. In this way, a visual dimension and a structural dimension may be integrated, so that an attribute feature that can generate attractiveness to a user in image data is comprehensively and accurately determined and used for more accurate subsequent editing of the target video.

In some embodiments, the visual-type label may specifically include label data used for representing an attribute feature that is determined by processing an image of a single piece of image data based on a visual dimension, is related to information such as content or emotion included in the target video, and generates attractiveness to a user.

In some embodiments, the visual-type label may specifically include at least one of the following: a text label, an article label, a face label, an aesthetic factor label, an emotional factor label, and the like.

The text label may specifically include a label used for representing a text feature in the image data. The article label may specifically include a label used for representing an article feature in the image data. The face label may specifically include a label used for representing a face feature of a human object in the image data. The aesthetic factor label may specifically include a label used for representing an aesthetic feature of a picture in the image data. The emotional factor label may specifically include a label used for representing an emotional or interest feature related to content in the image data.

It needs to be noted that for a user (or referred to as a target audience of a video) who is viewing and watching a video, the picture aesthetic of the image data in the video has an influence on whether the user is willing to click and view the target video. For example, if the picture of a video is beautiful and pleasing, the video is relatively attractive to the user, and the user is usually more willing to click and view the video and accept information conveyed by the video.

In addition, the emotion and interest related or implied in the content of the image data also have an influence on whether a user is willing to click and view the target video. For example, if the content of a video can better interest a user or the emotion implied in the content of a video better resonates with a user, the video is relatively attractive to the user, and the user is more willing to click and view the video and accept information conveyed by the video.

Therefore, in this example, it is proposed that an aesthetic factor label and/or an emotional factor label in image data may be determined and used as a basis for determining on a mental level whether the image data is attractive to a user or excites the attention of a user, to subsequently determine whether the image data is worth keeping.

Certainly, the listed visual-type label is only a schematic description. During specific implementation, according to a specific application scenario and processing requirement, a label of another type different from the listed label may be introduced as a visual-type label. This is not limited in the present disclosure.

In some embodiments, the structure-type label may specifically include label data used for representing an attribute feature that is determined by associating a feature of the image data and a feature of another piece of image data in the target video based on a structural dimension, is related to the structure and layout of the target video, and is attractive to a user.

In some embodiments, the structure-type label may specifically include at least one of the following: a dynamic attribute label, a static attribute label, a time domain attribute label, and the like.

The dynamic attribute label may specifically include a label used for representing a dynamic feature (for example, an action feature) of a target object (for example, an object such as a person or an article in the image data) in the image data. The static attribute label may specifically include a label used for representing a static feature (for example, a still state feature) of a target object in the image data. The time domain attribute label may specifically include a label used for representing a corresponding time domain feature of the image data relative to the entire target video. The time domain may specifically include a head time domain, an intermediate time domain, a tail time domain, and the like.

It should be noted that for a maker of a target video, during specific making of the target video, the maker usually makes some structural layout. For example, some pictures that tend to attract the attention of a user may be arranged in a head time domain (for example, a beginning position) of the target video; subject content that the target video is to convey may be arranged in an intermediate time domain (for example, an intermediate position) of the target video; and key information such as a purchase link and a coupon of a commodity that a user is expected to remember in the target video is arranged in a tail time domain (for example, an end position) of the target video.

Therefore, in this example, it is proposed that the time domain attribute label of the image data may be determined and used as a basis for determining, based on a making layout and a narrative level of the video, whether the image data carries relatively important content data in the target video, to subsequently determine whether the image data is worth keeping.

In addition, during the making of the target video, the maker further designs some actions or states of a target object to convey relatively important content information to people.

Therefore, in this example, the dynamic attribute label and/or the static attribute label of the image data may be determined and used as a basis for further determining more precisely whether the image data carries relatively important content data in the target video, to subsequently determine whether the image data is worth keeping.

Certainly, the above listed structure-type label is only a schematic description. During specific implementation, according to a specific application scenario and processing requirement, a label of another type different from the listed label may be introduced as a structure-type label. This is not limited in the present disclosure.

In some embodiments, during specific implementation, the extracting a plurality of pieces of image data from the target video may include: downsampling the target video, to obtain a plurality of pieces of image data by sampling. In this way, the data processing amount of the server can be effectively reduced, thereby improving the overall data processing efficiency.

In some embodiments, specifically, one piece of image data may be extract from the target video at preset time intervals (for example, 1s), to obtain a plurality of pieces of image data.

In some embodiments, for the determining the image label of the image data, for different types of image labels of image data, corresponding determination manners are used for determination.

Specifically, for a visual-type label, feature processing may be separately performed on each piece of image data in the plurality of pieces of image data to determine a visual-type label corresponding to each piece of image data. For a structure-type label, a feature of the image data and a feature of another piece of image data in the target video may be associated respectively; or a feature of each piece of the image data may be associated an overall feature of the target video, to determine a structure-type label of the image data.

In some embodiments, for the text label, during determination, an image feature related to a text (for example, a character, a letter, a number, or a symbol that appears in the image data) may be first extracted from the image data; and then recognition and matching are performed on the image feature related to a text, and a corresponding text label is determined according to a result of the recognition and matching.

In some embodiments, for the article label, during determining, an image feature used for representing an article may be first extracted from the image data; and then recognition and matching are performed on the image feature representing an article, and a corresponding article label is determined according to a result of the recognition and matching.

In some embodiments, for the face label, during determining, image data used for representing a person may be extracted from the image data; then image data representing a human face area is extracted from the image data representing a person; and feature extraction may be performed on the image data representing a human face area, and determine a corresponding face label according to the extracted face feature.

In some embodiments, for the aesthetic factor label, during determining, a preset aesthetic scoring model may be invoked to process the image data to obtain a corresponding aesthetic score, where the aesthetic score is used for representing attractiveness generated to a user from the image data based on picture aesthetic; and then the aesthetic factor label of the image data is determined according to the aesthetic score.

Specifically, for example, the preset aesthetic scoring model may be used to determine an aesthetic score of the image data; and then the aesthetic score is compared with a preset aesthetic score threshold, and if the aesthetic score is greater than the preset aesthetic score threshold, it indicates that the image data generates relatively high attractiveness to a user based on picture aesthetic, so that the aesthetic factor label of the image data may be determined as a strong aesthetic factor.

The preset aesthetic scoring model may specifically include a scoring model established by training and learning in advance a lot of image data labeled with aesthetic scores.

In some embodiments, for the emotional factor label, during determining, a preset emotional scoring model may be invoked to process the image data to obtain a corresponding emotional score. The emotional score is used for representing attractiveness generated to a user from the image data based on emotion and interest. Then, the emotional factor label of the image data is determined according to the emotional score.

Specifically, for example, the preset emotional scoring model may be used to determine an emotional score of the image data. Then, the emotional score is compared with a preset emotional score threshold. If the emotional score is greater than the preset emotional score threshold, it indicates that the image data generates relatively high attractiveness to a user based on emotion, interest or the like related to content, so that the emotional factor label of the image data may be determined as a strong emotional factor.

The preset emotional scoring model may specifically include a scoring model established and obtained by training and learning in advance a lot of image data labeled with emotional scores.

In some embodiments, for the dynamic attribute label, during determining, image data adjacent before and after the image data for which a label is to be determined may be first acquired as reference data; then a pixel indicating a target object (for example, a person in the image data) in the image data is acquired as an object pixel, and a pixel indicating the target object in the reference data is acquired as a reference pixel; the object pixel is further compared with the reference pixel to determine an action of the target object (for example, a gesture made by the target object in the image data); and then the dynamic attribute label of the image data is determined according to the action of the target object.

Specifically, for example, the server may use a previous frame image data and a next frame image data of current image data as reference data; further acquire a pixel of a human object in the current image data as an object pixel and use a pixel corresponding to a person in the reference data as a reference pixel, respectively; determine an action of the human object in the current image data by comparing a difference between the object pixel and the reference pixel; then match and compare the action of the human object in the current image data with preset actions representing different meanings or moods, determine a meaning or mood represented by the action in the current image data according to a result of the matching and comparison, and may further determine a corresponding dynamic attribute label according to the meaning or mood.

In some embodiments, the determination of a static attribute label is similar to the determination of a dynamic attribute label. During specific implementation, image data adjacent before and after the image data may be acquired as reference data; a pixel indicating a target object in the image data is acquired as an object pixel. A pixel indicating the target object in the reference data is acquired as a reference pixel. The object pixel is compared with the reference pixel to determine a still state of the target object (for example, a sitting gesture of the target object in the image data). Then the static attribute label of the image data is determined according to the still state of the target object.

In some embodiments, for the time domain attribute label, during specific determining, a corresponding time point of the image data in the target video may be first determined. A time domain corresponding to the image data is then determined according to the time point of the image data in the target video and a total duration of the target video, where the time domain includes a head time domain, a tail time domain, and an intermediate time domain. The time domain attribute label of the image data is determined according to the time domain corresponding to the image data.

Specifically, for example, the server may first determine that a time point corresponding to the current image data is 00:10, that is, the 10th second after the target video is started; determine that a total duration of the target video is 300 seconds; then may calculate, according to the time point corresponding to the image data and the total duration of the target video, that a duration ratio is 1/30, where the duration ratio is a ratio of a duration between the start of the target video and the time point corresponding to the image data to the total duration of the target video; and then determine, according to the duration ratio and a preset time domain division rule, that the time point corresponding to the image data is located in the first 10% time domain of the total duration of the target video, and determine that the time domain corresponding to the image data is the head time domain, and the time domain attribute label of the image data is determined as the head time domain.

In some embodiments, during specific implementation, one or more image labels of different types corresponding to each piece of image data in the plurality of pieces of image data may be determined in the above listed manner.

In some embodiments, during specific implementation, after one or more different image labels of each piece of the image data are determined, the determined image label(s) or mark information used for indicating the determined image label(s) may be set in each piece of the image data, so that the image data carries one or more image labels of different types or the mark information used for indicating the image label(s).

At S505, a type of the target video is determined, and a target editing model for the target video is established according to the type of the target video, the duration parameter, and a plurality of preset editing technique submodels.

In some embodiments, the preset editing technique submodel may specifically include a function model that can correspondingly edit a video based on an editing characteristic of an editing technique. One preset editing technique submodel corresponds to one editing technique.

In some embodiments, corresponding to different types of editing techniques (for example, a camera shot editing technique, an indoor/outdoor scene editing technique, and an emotional fluctuation editing technique), the preset editing technique submodel may correspondingly include a plurality of editing technique submodels of different types. Specifically, the preset editing technique submodels may include at least one of the following: an editing technique submodel corresponding to a camera shot editing technique, an editing technique submodel corresponding to an indoor/outdoor scene editing technique, an editing technique submodel corresponding to an emotional fluctuation editing technique, an editing technique submodel corresponding to a dynamic editing technique, an editing technique submodel corresponding to a recency effect editing technique, an editing technique submodel corresponding to a primacy effect editing technique, an editing technique submodel corresponding to a suffix effect editing technique, and the like. Certainly, it should be noted that the listed preset editing technique submodel is only a schematic description. During specific implementation, according to a specific application scenario and processing requirement, an editing technique submodel of another type different from the above listed preset editing technique submodel may be introduced. This is not limited in the present disclosure.

In some embodiments, the plurality of preset editing technique submodels may be established in advance in the following manner: learning in advance editing techniques of different types to determine editing characteristics of editing techniques of different types; then establishing editing rules for different editing techniques according to the editing characteristics of the editing techniques of different types; and generating an editing technique submodel corresponding to an editing technique according to the editing rules as a preset editing technique submodel.

In some embodiments, the target editing model may specifically include a model that is established for the target video and is used for specifically editing the target video. The target editing model is obtained by combining a plurality of different preset editing technique submodels. Therefore, a plurality of different editing techniques can be flexibly and effectively integrated.

In some embodiments, during specific implementation, the determining a type of the target video may include: determine content that the target video is to convey by performing image recognition and semantic recognition on the target video; and automatically determining the type of the target video according to the foregoing content. The determining a type of the target video may also include: extracting, from the parameter data, a type parameter of the target video set by the user, and efficiently determine the type of the target video according to the type parameter of the target video.

In some embodiments, during specific implementation, the establishing a target editing model for the target video according to the type of the target video, the duration parameter, and a plurality of preset editing technique submodels may include the following content: determining, from weight parameter groups of a plurality of groups of preset editing technique submodels according to the type of the target video, a weight parameter group of a preset editing technique submodel matching the type of the target video as a target weight parameter group, where the target weight parameter group includes preset weights that respectively correspond to the plurality of preset editing technique submodels; and establishing the target editing model for the target video according to the target weight parameter group, the duration parameter, and the plurality of preset editing technique submodels.

In some embodiments, the weight parameter groups of the plurality of groups of preset editing technique submodels may specifically include weight parameter groups of corresponding preset editing technique submodels that are established by learning and training in advance editing of a plurality of videos of different types and separately match editing of the videos of a plurality of types. The weight parameter groups of the plurality of groups of preset editing technique submodels may include a plurality of weight parameters, and each weight parameter corresponds to one preset editing technique. A weight parameter group of each group of preset editing technique submodels in the weight parameter groups of the plurality of groups of preset editing technique submodels corresponds to one video type.

In some embodiments, before specific implementation, editing of a large number of videos of different types may be learned in advance. Types of editing techniques and a combination manner of editing techniques, used by an editor during editing of videos of different types, are learned, so that weight parameter groups of a plurality of groups of preset editing technique submodels corresponding to editing of videos of different types may be established and obtained.

In some embodiments, the weight parameter groups of the plurality of groups of preset editing technique submodels may be specifically acquired in the following manner: acquiring a sample video and a sample synopsis video of the sample video as sample data, where the sample video includes videos of a plurality of types; labeling the sample data to obtain labeled sample data; and learning the labeled sample data, and determining the weight parameter groups of the plurality of groups of preset editing technique submodels corresponding to the videos of the plurality of types.

In some embodiments, during specific implementation, the labeling the sample data may include: labeling a video type of the sample video in the sample data from the sample data; and then determining, from the sample synopsis video in the sample data according to the sample video and the sample synopsis video in the sample data, an image label of image data (for example, image data in the sample synopsis video) kept in an editing process, and labeling a corresponding image label in the image data in the sample synopsis video. In addition, an editing technique used in a process of editing the sample video to obtain the sample synopsis video is determined by comparing the sample video and the sample synopsis video, so that a type of the used editing technique may be labeled in the sample data. Then, the labeling of the sample data is completed.

In some embodiments, during specific implementation, the learning the labeled sample data, and determining the weight parameter groups of the plurality of groups of preset editing technique submodels corresponding to the videos of the plurality of types may include: using a maximum margin learning framework as a learning model. weight parameter groups of a plurality of groups of preset editing technique submodels corresponding to editing of videos of a plurality of types can be efficiently and accurately determined by keep learning the inputted labeled sample data by the learning model. Certainly, it should be noted that the listed maximum margin learning framework is only a schematic description. During specific implementation, another appropriate model structure may be used as a learning model to determine the weight parameter groups of a plurality of groups of preset editing technique submodels.

In some embodiments, during specific implementation, the establishing the target editing model for the target video according to the target weight parameter group, the duration parameter, and the plurality of preset editing technique submodels may include the following content: determining preset weights of the plurality of preset editing technique submodels according to the target weight parameter group; and then combining a plurality of preset editing technique submodels according to the preset weights of the plurality of preset editing technique submodels to obtain a combined model. In addition, a time constraint of an optimized target function in the combined model is set according to a duration parameter, so that a target editing model may be established and obtained, and the target editing model is designed for the target video, is suitable for editing the target video, and integrates a plurality of different editing techniques.

In some embodiments, during specific implementation, during the acquisition of parameter data, the user may be further allowed to set a weight parameter of each preset editing technique submodel in the plurality of preset editing technique submodels, according to preferences and requirements of the user for use, as a customized weight parameter group. Correspondingly, during the establishment of the target editing model, the customized weight parameter group set by the user may be further extracted from the parameter data, and then a target editing model satisfying customization requirements of the user can be efficiently constructed according to the customized weight parameter group, the duration parameter, and the plurality of preset editing technique submodels.

At S507, the target video according to the image label of the image data in the target video is edited by using the target editing model to obtain the synopsis video of the target video.

In some embodiments, during specific implementation, the target video may be invoked to specifically edit the target video according to the image label of the image data in the target video, to obtain a synopsis video that can accurately cover the main content the target video and has relatively high attractiveness.

In some embodiments, during specific implementation, whether to keep a plurality of pieces of image data in the target video may be determined one by one by using the target editing model and according to the visual-type label of the image data. Then the determined image data to be kept is spliced to obtain a corresponding synopsis video. In this way, according to an attribute feature that generates attractiveness to a user based on a visual dimension of the image data in the target video, and in combination with psychological factors of a user, the target video is edited in a targeted manner on a visual dimension, so that a synopsis video of the target video that is highly attractive to a user is obtained.

In some embodiments, during specific implementation, whether to keep a plurality of pieces of image data in the target video may be further determined one by one by using the target editing model and according to the image labels of a plurality of different dimensions (such as a visual-type label and/or a structure-type label of the image data). Then, the determined image data to be kept is spliced to obtain a corresponding synopsis video.

When the corresponding target editing model is constructed in the foregoing manner, and the target video is edited by using the target editing model and according to different image labels such as a visual-type label and/or a structure-type label of the image data, since based on content narrative and the psychology of a user, a plurality of editing techniques suitable for a type of the target video are combined in a targeted manner and dimensions of two different types (that is, content vision and a layout structure) are integrated, the target video is automatically and efficiently edited in a target manner. Therefore, a synopsis video that conforms to an original target video, has accurate content summary, and is highly attractive to a user is obtained.

In some embodiments, after the corresponding synopsis video is obtained by editing the target video in the foregoing manner, the synopsis video may be further placed to a corresponding short video platform or a video promotion page. By means of the synopsis video, content and information that the target video is to convey can be accurately transferred to a user, and the synopsis video is relatively attractive to a user and tends to excite the interest of a user and resonate with a user, so that the information that the target video is to transfer can be better transferred to a user, thereby achieving a better placement effect.

In some embodiments of the present disclosure, a plurality of pieces of image data are first extracted from a target video. An image label such as a visual-type label of the image data is determined respectively, where the image label includes at least a visual-type label used for representing an attribute feature generating attractiveness to a user based on a visual dimension in the image data. A target editing model for the target video is established according to a type of the target video and a duration parameter of a synopsis video of the target video and in combination with a plurality of preset editing technique submodels. The target editing model may then be used to edit the target video in a targeted manner according to the image label of the image data in the target video and based on a visual dimension. Therefore, a synopsis video can be efficiently generated, where the synopsis video conforms to an original target video, has accurate content, and is highly attractive to a user.

In some embodiments, during specific implementation, the establishing a target editing model for the target video according to the type of the target video, the duration parameter, and a plurality of preset editing technique submodels may include: determining, from weight parameter groups of a plurality of groups of preset editing technique submodels according to the type of the target video, a weight parameter group of a preset editing technique submodel matching the type of the target video as a target weight parameter group, where the target weight parameter group includes preset weights that respectively correspond to the plurality of preset editing technique submodels; and establishing the target editing model for the target video according to the target weight parameter group, the duration parameter, and the plurality of preset editing technique submodels.

In some embodiments, the weight parameter groups of the plurality of groups of preset editing technique submodels may be specifically acquired in the following manner: acquiring a sample video and a sample synopsis video of the sample video as sample data, where the sample video includes videos of a plurality of types; labeling the sample data to obtain labeled sample data; and learning the labeled sample data, and determining the weight parameter groups of the plurality of groups of preset editing technique submodels corresponding to the videos of the plurality of types.

In some embodiments, during specific implementation, the labeling the sample data may include: labeling a type of the sample video in the sample data; and determining and labeling, according to the sample video and the sample synopsis video in the sample data, an image label of image data included in the sample synopsis video from the sample data and an editing technique type corresponding to the sample synopsis video.

In some embodiments, the preset editing technique submodels may specifically include at least one of the following: an editing technique submodel corresponding to a camera shot editing technique, an editing technique submodel corresponding to an indoor/outdoor scene editing technique, an editing technique submodel corresponding to an emotional fluctuation editing technique, an editing technique submodel corresponding to a dynamic editing technique, an editing technique submodel corresponding to a recency effect editing technique, an editing technique submodel corresponding to a primacy effect editing technique, an editing technique submodel corresponding to a suffix effect editing technique, and the like.

In some embodiments, the preset editing technique submodels may be specifically generated in the following manner: determining a plurality of editing rules corresponding to a plurality of editing technique types according to editing characteristics of editing techniques of different types; and establishing a plurality of preset editing technique submodels corresponding to the plurality of editing technique types according to the plurality of editing rules.

In some embodiments, the visual-type label may specifically include at least one of the following: a text label, an article label, a face label, an aesthetic factor label, an emotional factor label, and the like.

In some embodiments, during specific implementation, in a case that the image label includes the aesthetic factor label, the determining an image label of image data may include: invoking a preset aesthetic scoring model to process the image data to obtain a corresponding aesthetic score, where the aesthetic score is used for representing attractiveness generated to a user from the image data based on picture aesthetic; and then determining the aesthetic factor label of the image data according to the aesthetic score.

In some embodiments, during specific implementation, in a case that the image label includes the emotional factor label, the determining an image label of image data may include: invoking a preset emotional scoring model to process the image data to obtain a corresponding emotional score, where the emotional score is used for representing attractiveness generated to a user from the image data based on emotion and interest; and determining the emotional factor label of the image data according to the emotional score.

In some embodiments, the image label may further include a structure-type label. The structure-type label may specifically include a label used for representing an attribute feature generating attractiveness to a user based on a structural dimension in the image data.

In some embodiments, the structure-type label may specifically include at least one of the following: a dynamic attribute label, a static attribute label, a time domain attribute label, and the like.

In some embodiments, during specific implementation, in a case that the image label includes the dynamic attribute label, the determining an image label of image data may include: acquiring image data adjacent before and after the current image data as reference data; acquiring a pixel indicating a target object in the image data as an object pixel, and acquiring a pixel indicating the target object in the reference data as a reference pixel; further comparing the object pixel with the reference pixel to determine an action of the target object; and determining the dynamic attribute label of the image data according to the action of the target object.

In some embodiments, during specific implementation, in a case that the image label includes the time domain attribute label, the determining an image label of image data may include: determining a time point of the image data in the target video; determining a time domain corresponding to the image data according to the time point of the image data in the target video and a total duration of the target video, where the time domain includes a head time domain, a tail time domain, and an intermediate time domain; and determining the time domain attribute label of the image data according to the time domain corresponding to the image data.

In some embodiments, the target video may specifically include a video for a commodity promotion scenario. Certainly, the target video may further include a video corresponding another application scenario. For example, the target video may be a tourism promotion video for a city, a service presentation and introduction video of a company, or the like. This is not limited in the present disclosure.

In some embodiments, the type of the target video may specifically include at least one of the following: a clothing type, a food type, a cosmetics type, and the like. Certainly, the above listed types are only a schematic description. During specific implementation, according to a specific case, another video type may be further included.

In some embodiments, the parameter data may specifically further include a customized weight parameter group. In this way, a user may be allowed to combine a plurality of preset editing technique submodels according to preferences and requirements of the user, to establish a target editing model satisfying customization requirements of the user, so that the target video can be edited according to customization requirements of the user to obtain a corresponding synopsis video.

In some embodiments, the parameter data may specifically further include a type parameter used for indicating the type of the target video. In this way, the type of the target video may be directly determined according to the type parameter in the parameter data, so that additional determination of the type of the target video can be avoided, thereby reducing the data processing amount and improving the processing efficiency.

As can be seen from above, in the method for generating a synopsis video provided in the embodiments of the present disclosure, a plurality of pieces of image data are first extracted from a target video, and an image label such as a visual-type label of the image data is separately determined, where the image label includes at least a visual-type label used for representing an attribute feature generating attractiveness to a user based on a visual dimension in the image data; then a target editing model for the target video is established according to a type of the target video and a duration parameter of a synopsis video of the target video and in combination with a plurality of preset editing technique submodels; and the target editing model may then be used to edit the target video in a targeted manner according to the image label of the image data in the target video and based on a visual dimension, so that a synopsis video that conforms to an original target video, has accurate content, and is highly attractive to a user can be efficiently generated. Further, the visual-type label and the structure-type label of the image data are simultaneously determined and used as image labels. Two different dimensions, that is, visual content and a structural layout, are integrated, to edit the target video in a targeted manner, so that the target video can be better edited to generate a synopsis video that conforms to an original target video, has accurate content, and is highly attractive to a user. Further, a large amount of labeled sample data of different types is learned in advance to establish weight parameter groups of a plurality of groups of preset editing technique submodels corresponding to videos of a plurality of types. In this way, during editing of target videos of different types, a matching target weight parameter group can be efficiently determined according to a type of a target video, and a plurality of preset editing technique submodels are combined according to the target weight parameter group, to obtain the target editing model for the target video, so that the target video is specifically edited, to achieve the applicability to target videos of a plurality of different types, thereby efficiently editing target videos.

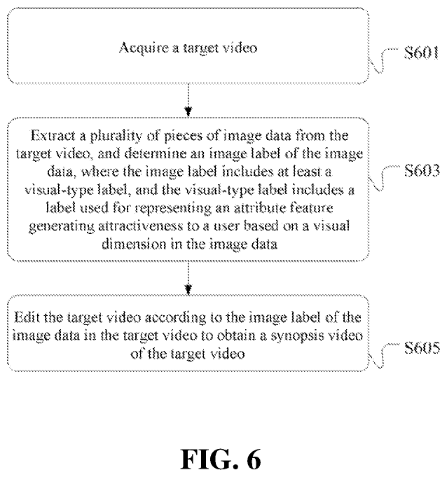

Referring to FIG. 6, embodiments of the present disclosure further provide another method for generating a synopsis video. During specific implementation, the method may include the following steps.

At S601, a target video is acquired.

At S603, a plurality of pieces of image data is extracted from the target video, and an image label of the image data is determined, where the image label includes at least a visual-type label, and the visual-type label includes a label used for representing an attribute feature generating attractiveness to a user based on a visual dimension in the image data.

At S605, the target video is edited according to the image label of the image data in the target video to obtain a synopsis video of the target video.

In some embodiments, the visual-type label may specifically include at least one of the following labels: a text label, an article label, a face label, an aesthetic factor label, an emotional factor label, and the like. The visual-type label may be relatively efficiently used for representing an attribute feature generating attractiveness to a user based on a visual dimension in the image data.

Further, an aesthetic factor label, an emotional factor label, and the like in the visual-type label may be determined and used, psychological factors of a user watching a video are introduced and used to specifically edit the target video, to obtain a synopsis video that is highly attractive to a user on a mental level based on a visual dimension.

In the embodiments of the present disclosure, the visual-type label of the image data in the target video may be determined as the image label; and then the target video is specifically edited according to the image label of the image data in the target video, so that according to an attribute feature which generates attractiveness to a user based on a visual dimension of the image data in the target video, and in combination with psychological factors of a user, the target video is edited in a targeted manner on a visual dimension, to obtain a synopsis video of the target video that is highly attractive to a user.

In some embodiments, the image label may specifically further include a structure-type label. The structure-type label includes a label used for representing an attribute feature generating attractiveness to a user based on a structural dimension in the image data.

In some embodiments, the structure-type label may specifically include at least one of the following labels: a dynamic attribute label, a static attribute label, a time domain attribute label, and the like.

In the embodiments of the present disclosure, the visual-type label and/or structure-type label of the image data in the target video may further be determined as the image label; and then the target video is specifically edited according to the image label of the image data in the target video, so that two different dimensions, that is, visual content and a structural layout, may be integrated, to edit the target video in a targeted manner, to generate a synopsis video that conforms to an original target video, has accurate content, and is highly attractive to a user.

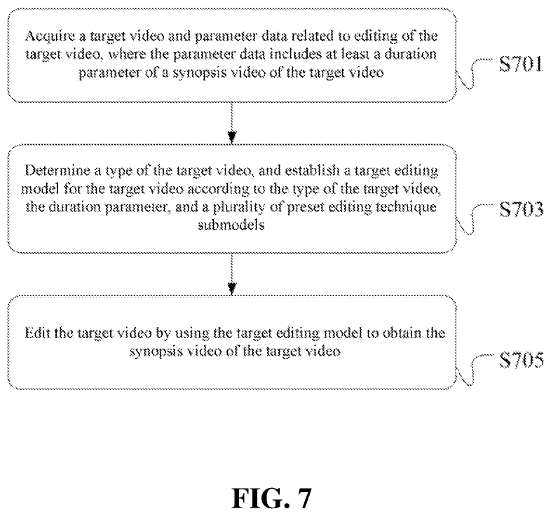

Referring to FIG. 7, embodiments of the present disclosure further provide another method for generating a synopsis video. During specific implementation, the method may include the following steps.

At S701, a target video and parameter data related to editing of the target video are acquired, where the parameter data includes at least a duration parameter of a synopsis video of the target video.

At S703, a type of the target video is determined, and a target editing model for the target video is established according to the type of the target video, the duration parameter, and a plurality of preset editing technique submodels.

At S705, the target video is edited by using the target editing model to obtain the synopsis video of the target video.

In some embodiments, during specific implementation, the establishing a target editing model for the target video according to the type of the target video, the duration parameter, and a plurality of preset editing technique submodels may include the following content: determining, according to the type of the target video, a weight parameter group of a preset editing technique submodel matching the type of the target video as a target weight parameter group, where the target weight parameter group includes preset weights that respectively correspond to the plurality of preset editing technique submodels; and establishing the target editing model for the target video according to the duration parameter, the target weight parameter group, and the plurality of preset editing technique submodels.

In some embodiments, the weight parameter groups of the plurality of groups of preset editing technique submodels may be specifically acquired in advance in the following manner: acquiring a sample video and a sample synopsis video of the sample video as sample data, where the sample video includes videos of a plurality of types; labeling the sample data to obtain labeled sample data; and learning the labeled sample data, and determining weight parameter groups of a plurality of groups of preset editing technique submodels corresponding to the videos of the plurality of types.

In some embodiments, during specific implementation, the learning the labeled sample data may include: constructing a maximum margin learning framework; and learning the labeled sample data by using the maximum margin learning framework.

In the embodiments of the present disclosure, a matching target weight parameter group can be determined according to a type of a target video; then a plurality of preset editing technique submodels are combined according to the target weight parameter group, to establish and obtain a target editing model that is for the target video and integrates a plurality of corresponding editing techniques; and the target video is specifically edited by using the target editing model, to achieve the applicability to target videos of a plurality of different types, thereby efficiently and accurately editing the target videos of different types.

The embodiments of the present disclosure further provide a method for generating a target editing model. During specific implementation, the method may include the following steps.

At S1, parameter data related to editing of a target video is acquired, where the parameter data includes at least a duration parameter of a synopsis video of the target video.

At S2, a type of the target video is determined, and a target editing model for the target video is established according to the type of the target video, the duration parameter, and a plurality of preset editing technique submodels.

In some embodiments, during specific implementation, the establishing a target editing model for the target video according to the type of the target video, the duration parameter, and a plurality of preset editing technique submodels may include the following content: determining, according to the type of the target video, a weight parameter group of a preset editing technique submodel matching the type of the target video as a target weight parameter group, where the target weight parameter group includes preset weights that respectively correspond to the plurality of preset editing technique submodels; and establishing the target editing model for the target video according to the duration parameter, the target weight parameter group, and the plurality of preset editing technique submodels.

In the embodiments of the present disclosure, for different target videos to be edited, according to a determined type of the target video and in combination with a duration parameter and a plurality of preset editing technique submodels, a target editing model targeted for the target video may be established and obtained, which can be suitable for editing requirements of target videos of a plurality of different types. Therefore, a target editing model that is relatively targeted and has a relatively adequate editing effect is established and obtained.

The embodiments of the present disclosure further provide a server, including a processor and a memory configured to store instructions executable by the processor. During specific implementation, the processor may perform the following steps according to the instructions: acquiring a target video and parameter data related to editing of the target video, where the parameter data includes at least a duration parameter of a synopsis video of the target video; extracting a plurality of pieces of image data from the target video, and determining an image label of the image data, where the image label includes at least a visual-type label; determining a type of the target video, and establishing a target editing model for the target video according to the type of the target video, the duration parameter, and a plurality of preset editing technique submodels; and editing the target video according to the image label of the image data in the target video by using the target editing model to obtain the synopsis video of the target video.

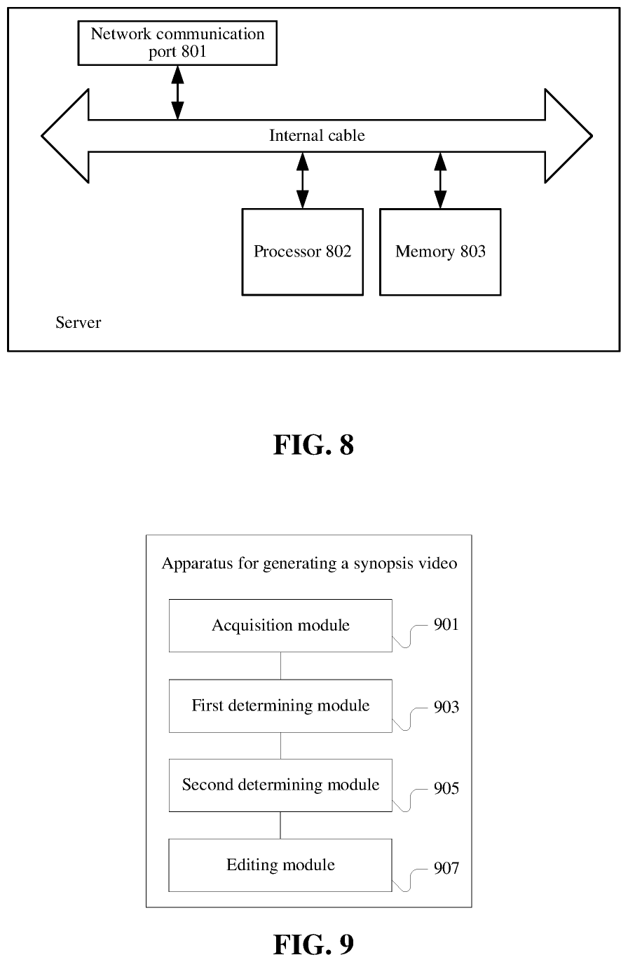

To more accurately complete the foregoing instructions, referring to FIG. 8, the embodiments of the present disclosure further provide another specific server. The server includes a network communication port 801, a processor 802, and a memory 803. The foregoing structures are connected by an internal cable, so that the structures can perform specific data interaction.

The network communication port 801 may be specifically configured to acquire a target video and parameter data related to editing of the target video, where the parameter data includes at least a duration parameter of a synopsis video of the target video.

The processor 802 may be specifically configured to: extract a plurality of pieces of image data from the target video, and determine an image label of the image data, where the image label includes at least a visual-type label; determine a type of the target video, and establish a target editing model for the target video according to the type of the target video, the duration parameter, and a plurality of preset editing technique submodels; and edit the target video according to the image label of the image data in the target video by using the target editing model to obtain the synopsis video of the target video.

The memory 803 may be specifically configured to store a corresponding instruction program.

In this example, the network communication port 801 may be a virtual port that is bound to a different communication protocol to send or receive different data. For example, the network communication port may be a port 80 responsible for web data communication, or a port 21 responsible for FTP data communication, or a port 25 responsible for email data communication. In addition, the network communication port may be a physical communication interface or communication chip. For example, the network communication port may be a wireless mobile network communication chip such as a GSM chip or a CDMA chip; or the network communication port may be a Wi-Fi chip; or the network communication port may be a Bluetooth chip.

In this example, the processor 802 may be implemented in any appropriate manner. For example, the processor may take the form of, for example, one or more of a microprocessor or processor and a computer-readable medium storing computer-readable program code (for example, software or firmware) executable by one or more processors, a logic gate, a switch, an application-specific integrated circuit (Application Specific Integrated Circuit, ASIC), a programmable logic controller, an embedded microcontroller, and the like. This is not limited in the present disclosure.

In this example, the memory 803 may include a plurality of levels. In a digital system, anything that can store binary data may be a memory. In an integrated circuit, a circuit with a storage function but no physical form is a memory, for example, a RAM, or a FIFO. In a system, a storage device with a physical form is a memory, for example, a memory stick, or a TF card.

The embodiments of the present disclosure further provide a computer storage medium based on the foregoing method for generating a synopsis video, the computer storage medium storing computer program instructions, the computer program instructions, when being executed, implement: acquiring a target video and parameter data related to editing of the target video, where the parameter data includes at least a duration parameter of a synopsis video of the target video; extracting a plurality of pieces of image data from the target video, and determining an image label of the image data, where the image label includes a visual-type label and/or a structure-type label; determining a type of the target video, and establishing a target editing model for the target video according to the type of the target video, the duration parameter, and a plurality of preset editing technique submodels; and editing the target video according to the image label of the image data in the target video by using the target editing model to obtain the synopsis video of the target video.

In this example, the storage medium includes, but is not limited to, a random access memory (Random Access Memory, RAM), a read-only memory (Read-Only Memory, ROM), a cache (Cache), a hard disk drive (Hard Disk Drive, HDD) or a memory card (Memory Card). The memory may be configured to store computer program instructions. A network communication unit may be an interface that is set according to standards specified in communication protocols and is configured to perform network connection communication.

In this example, for the functions and effects specifically implemented by program instructions stored in the computer storage medium, reference may be made to other embodiments for description. Details are not described herein again.

Referring to FIG. 9, on a software level, the embodiments of the present disclosure further provide an apparatus for generating a synopsis video. The apparatus may specifically include the following structural modules:

an acquisition module 901, configured to acquire a target video and parameter data related to editing of the target video, where the parameter data includes at least a duration parameter of a synopsis video of the target video;

a first determining module 903, configured to extract a plurality of pieces of image data from the target video, and determine an image label of the image data, where the image label includes at least a visual-type label;

a second determining module 905, configured to determine a type of the target video, and establish a target editing model for the target video according to the type of the target video, the duration parameter, and a plurality of preset editing technique submodels; and

an editing module 907, configured to edit the target video according to the image label of the image data in the target video by using the target editing model to obtain the synopsis video of the target video.

In some embodiments, during specific implementation, the second determining module 905 may include the following structural units:

a first determining unit, further configured to determine, from weight parameter groups of a plurality of groups of preset editing technique submodels according to the type of the target video, a weight parameter group of a preset editing technique submodel matching the type of the target video as a target weight parameter group, where the target weight parameter group includes preset weights that respectively correspond to the plurality of preset editing technique submodels; and

a first establishment unit, further configured to establish the target editing model for the target video according to the target weight parameter group, the duration parameter, and the plurality of preset editing technique submodels.

In some embodiments, the apparatus may acquire the weight parameter groups of the plurality of groups of preset editing technique submodels in the following manner: acquiring a sample video and a sample synopsis video of the sample video as sample data, where the sample video includes videos of a plurality of types; labeling the sample data to obtain labeled sample data; and learning the labeled sample data, and determining the weight parameter groups of the plurality of groups of preset editing technique submodels corresponding to the videos of the plurality of types.

In some embodiments, during specific implementation, the apparatus may label the sample data in the following manner: labeling a type of the sample video in the sample data; and determining and labeling, according to the sample video and the sample synopsis video in the sample data, an image label of image data included in the sample synopsis video from the sample data and an editing technique type corresponding to the sample synopsis video.

In some embodiments, the preset editing technique submodels may specifically include at least one of the following: an editing technique submodel corresponding to a camera shot editing technique, an editing technique submodel corresponding to an indoor/outdoor scene editing technique, an editing technique submodel corresponding to an emotional fluctuation editing technique, an editing technique submodel corresponding to a dynamic editing technique, an editing technique submodel corresponding to a recency effect editing technique, an editing technique submodel corresponding to a primacy effect editing technique, an editing technique submodel corresponding to a suffix effect editing technique, and the like.

In some embodiments, the apparatus may specifically further include a generation module, configured to generate the plurality of preset editing technique submodels in advance. During specific implementation, the generation module may be configured to determine a plurality of editing rules corresponding to a plurality of editing technique types according to editing characteristics of editing techniques of different types; and establish a plurality of preset editing technique submodels corresponding to the plurality of editing technique types according to the plurality of editing rules.

In some embodiments, the visual-type label may specifically include at least one of the following: a text label, an article label, a face label, an aesthetic factor label, an emotional factor label, and the like.

In some embodiments, during specific implementation, in a case that the image label includes the aesthetic factor label, the first determining module 903 may be configured to invoke a preset aesthetic scoring model to process the image data to obtain a corresponding aesthetic score, where the aesthetic score is used for representing attractiveness generated to a user from the image data based on picture aesthetic; and then determine the aesthetic factor label of the image data according to the aesthetic score.

In some embodiments, during specific implementation, in a case that the image label includes the emotional factor label, the first determining module 903 may be configured to invoke a preset emotional scoring model to process the image data to obtain a corresponding emotional score, where the emotional score is used for representing attractiveness generated to a user from the image data based on emotion and interest; and determine the emotional factor label of the image data according to the emotional score.

In some embodiments, the image label may specifically further include a structure-type label or the like.

In some embodiments, the structure-type label may specifically include at least one of the following: a dynamic attribute label, a static attribute label, a time domain attribute label, and the like.

In some embodiments, during specific implementation, in a case that the image label includes the dynamic attribute label, the first determining module 903 may be configured to acquire image data adjacent before and after the image data as reference data; acquire a pixel indicating a target object in the image data as an object pixel, and acquire a pixel indicating the target object in the reference data as a reference pixel; further compare the object pixel with the reference pixel to determine an action of the target object; and determine the dynamic attribute label of the image data according to the action of the target object.

In some embodiments, during specific implementation, in a case that the image label includes the time domain attribute label, the first determining module 903 may be configured to determine a time point of the image data in the target video; determine a time domain corresponding to the image data according to the time point of the image data in the target video and a total duration of the target video, where the time domain includes a head time domain, a tail time domain, and an intermediate time domain; and determine the time domain attribute label of the image data according to the time domain corresponding to the image data.

In some embodiments, the target video may specifically include a video for a commodity promotion scenario or the like.

In some embodiments, the type of the target video may specifically include at least one of the following: a clothing type, a food type, a cosmetics type, and the like.

In some embodiments, during specific implementation, the parameter data may further include a customized weight parameter group or the like.

In some embodiments, during specific implementation, the parameter data may specifically further include a type parameter used for indicating the type of the target video or the like.

It should be noted that the unit, the apparatus or the module described in the foregoing embodiments may be specifically implemented by a computer chip or an entity, or implemented by a product having a certain function. For ease of description, when the foregoing apparatus is described, the apparatus is divided into modules according to functions described respectively. Certainly, during implementation of the present disclosure, the functions of the modules may be implemented in the same piece of or a plurality of pieces of software and/or hardware, or modules implementing the same function may be implemented by using a combination of a plurality of submodules or subunits. The described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electric, mechanical, or other forms.

As can be seen from above, in the apparatus for generating a synopsis video provided in the embodiments of the present disclosure, the first determining module first extracts a plurality of pieces of image data from a target video, and separately determines an image label such as a visual-type label of the image data, where the image label includes at least a visual-type label used for representing an attribute feature generating attractiveness to a user based on a visual dimension in the image data; then the second determining module establishes a target editing model for the target video according to a type of the target video and a duration parameter of a synopsis video of the target video and in combination with a plurality of preset editing technique submodels; and then the editing module may use the target editing model to edit the target video in a targeted manner according to the image label of the image data in the target video and based on a visual dimension, so that a synopsis video that conforms to an original target video, has accurate content, and is highly attractive to a user can be efficiently generated.

The embodiments of the present disclosure further provide an apparatus for generating a synopsis video includes: an acquisition module, configured to acquire a target video and parameter data related to editing of the target video, where the parameter data includes at least a duration parameter of a synopsis video of the target video; a determining module, configured to determine a type of the target video, and establish a target editing model for the target video according to the type of the target video, the duration parameter, and a plurality of preset editing technique submodels; and an editing module, configured to edit the target video by using the target editing model to obtain the synopsis video of the target video.

The embodiments of the present disclosure further provide still another apparatus for generating a synopsis video, including: an acquisition module, configured to acquire a target video; a determining module, configured to extract a plurality of pieces of image data from the target video, and determine an image label of the image data, where the image label includes at least a visual-type label, and the visual-type label includes a label used for representing an attribute feature generating attractiveness to a user based on a visual dimension in the image data; and an editing module, configured to edit the target video according to the image label of the image data in the target video to obtain a synopsis video of the target video.

The embodiments of the present disclosure further provide an apparatus for generating a target editing model, including: an acquisition module, configured to acquire parameter data related to editing of a target video, where the parameter data includes at least a duration parameter of a synopsis video of the target video; and an establishment module, configured to determine a type of the target video, and establish a target editing model for the target video according to the type of the target video, the duration parameter, and a plurality of preset editing technique submodels.

Although the present disclosure provides method operation steps described in the embodiments or flowcharts, more or fewer operational steps may be included based on conventional means or non-creative means. The order of the steps listed in the embodiments is merely one of a plurality of step execution orders, and does not indicate the only execution order. When an actual apparatus or client product is executed, sequential execution or parallel execution may be performed according to the method orders shown in the embodiments or the accompanying drawings (for example, in a parallel processor or multi-thread processing environment, and even a distributed data processing environment). The term “include”, “comprise” or any other variation thereof is intended to cover a non-exclusive inclusion, which specifies the presence of stated processes, methods, products, or devices, but does not preclude the presence or addition of one or more other processes, methods, products, or devices. Without more limitations, does not exclude other same or equivalent elements existing in the process, the method, the product, or the device that includes the element. The words such as “first” and “second” are only used to denote names, and do not denote any particular order.

A person skilled in the art will also appreciate that, in addition to implementing the controller in the form of pure computer-readable program code, it is also possible to implement, by logically programming the method steps, the controller in the form of a logic gate, switch, ASIC, programmable logic controller, and embedded microcontroller and other forms to achieve the same function. Such a controller can thus be deemed as a hardware component and apparatuses included therein for implementing various functions can also be deemed as structures inside the hardware component. Alternatively, apparatuses configured to implement various functions can be considered as both software modules implementing the method and structures inside the hardware component.

The present disclosure can be described in the general context of computer-executable instructions executed by a computer, for example, program modules. Generally, the program module includes a routine, a program, an object, a component, a data structure, a class, and the like for executing a particular task or implementing a particular abstract data type. the present disclosure may be implemented in a distributed computing environment in which tasks are performed by remote processing devices connected by using a communication network. In a distributed computing environment, the program module may be located in both local and remote computer storage media including storage devices.

As can be seen from the foregoing description of the embodiments, a person skilled in the art can clearly learn that the present disclosure may be implemented by using software in combination with a necessary universal hardware platform. Based on such an understanding, the technical solutions of the present disclosure essentially may be implemented in a form of a software product. The computer software product may be stored in a storage medium such as a ROM/RAM, a magnetic disk, or an optical disc and includes several instructions for instructing a computer device (which may be a personal computer, a mobile terminal, a server, a network device, or the like) to perform the methods in the embodiments of the present disclosure or some parts of the embodiments.

The embodiments of the present disclosure are all described in a progressive manner, for same or similar parts in the embodiments, refer to these embodiments, and descriptions of each embodiment focus on a difference from other embodiments. The specification may be applicable to environments or configurations of multiple universal or dedicated computer systems, for example, a personal computer, a server computer, a handheld device or a portable device, a tablet device, a multi-processor system, a microprocessor-based system, a set-top box, a programmable electronic device, a network PC, a minicomputer, a mainframe computer, and a distributed computing environment including any one of the foregoing system or device.

Although the present disclosure is described through embodiments, it is known to a person skilled in the art that many variations may be made to the present disclosure without departing from the spirit of the present disclosure, and it is expected that the appended claims include these variations and changes without departing from the spirit of the present disclosure.

What is claimed is:

1. A method for generating a synopsis video, comprising:
acquiring a target video and parameter data related to editing of the target video, wherein the parameter data comprises at least a duration parameter of a synopsis video of the target video;
extracting a plurality of pieces of image data from the target video, and determining an image label of each piece of the plurality of pieces of the image data, wherein the image label comprises at least a visual-type label;
determining a type of the target video;
establishing a target editing model for the target video according to the type of the target video, the duration parameter, and a plurality of preset editing technique submodels; and
editing the target video according to the image label of the image data in the target video by using the target editing model to obtain the synopsis video of the target video.

2. The method according to claim 1, wherein the establishing a target editing model for the target video according to the type of the target video, the duration parameter, and the plurality of preset editing technique submodels comprises:
determining, from weight parameter groups of a plurality of groups of preset editing technique submodels according to the type of the target video, a weight parameter group of a preset editing technique submodel matching the type of the target video as a target weight parameter group, where the target weight parameter group comprises preset weights that respectively correspond to the plurality of preset editing technique submodels; and
establishing the target editing model for the target video according to the target weight parameter group, the duration parameter, and the plurality of preset editing technique submodels.

3. The method according to claim 2, where the weight parameter groups of the plurality of groups of preset editing technique submodels are acquired in following manner:
acquiring a sample video and a sample synopsis video of the sample video as sample data, wherein the sample video comprises videos of a plurality of types;
labeling the sample data to obtain labeled sample data; and
learning the labeled sample data, and determining the weight parameter groups of the plurality of groups of preset editing technique submodels corresponding to the videos of the plurality of types.

4. The method according to claim 3, wherein the labeling the sample data comprises:
labeling a type of the sample video in the sample data; and
determining and labeling, according to the sample video and the sample synopsis video in the sample data, an image label of image data comprised in the sample synopsis video from the sample data and an editing technique type corresponding to the sample synopsis video.

5. The method according to claim 1, wherein the preset editing technique submodels comprise at least one of:
an editing technique submodel corresponding to a camera shot editing technique, an editing technique submodel corresponding to an indoor/outdoor scene editing technique, an editing technique submodel corresponding to an emotional fluctuation editing technique, an editing technique submodel corresponding to a dynamic editing technique, an editing technique submodel corresponding to a recency effect editing technique, an editing technique submodel corresponding to a primacy effect editing technique, or an editing technique submodel corresponding to a suffix effect editing technique.

6. The method according to claim 5, wherein the preset editing technique submodels are generated in following manner:
determining a plurality of editing rules corresponding to a plurality of editing technique types according to editing characteristics of editing techniques of different types; and
establishing a plurality of preset editing technique submodels corresponding to the plurality of editing technique types according to the plurality of editing rules.

7. The method according to claim 1, wherein the visual-type label comprises at least one of: a text label, an article label, a face label, an aesthetic factor label, or an emotional factor label.

8. The method according to claim 7, wherein in a case that the image label comprises the aesthetic factor label, the determining the image label of image data comprises:
invoking a preset aesthetic scoring model to process the image data to obtain a corresponding aesthetic score, wherein the aesthetic score is used for representing attractiveness generated to a user from the image data based on picture aesthetic; and
determining the aesthetic factor label of the image data according to the aesthetic score.

9. The method according to claim 7, wherein in a case that the image label comprises the emotional factor label, the determining the image label of image data comprises:
invoking a preset emotional scoring model to process the image data to obtain a corresponding emotional score, wherein the emotional score is used for representing attractiveness generated to a user from the image data based on emotional interest; and
determining the emotional factor label of the image data according to the emotional score.

10. The method according to claim 1, wherein the image label further comprises a structure-type label.

11. The method according to claim 10, wherein the structure-type label comprises at least one of: a dynamic attribute label, a static attribute label, or a time domain attribute label.

12. The method according to claim 11, wherein in a case that the image label comprises the dynamic attribute label, the determining the image label of image data comprises:
acquiring image data adjacent before and after the image data as reference data;
acquiring a pixel indicating a target object in the image data as an object pixel, and acquiring a pixel indicating the target object in the reference data as a reference pixel;
comparing the object pixel with the reference pixel to determine an action of the target object; and
determining the dynamic attribute label of the image data according to the action of the target object.

13. The method according to claim 11, wherein in a case that the image label comprises the time domain attribute label, the determining the image label of image data comprises:
determining a time point of the image data in the target video;
determining a time domain corresponding to the image data according to the time point of the image data in the target video and a total duration of the target video, wherein the time domain comprises a head time domain, a tail time domain, and an intermediate time domain; and
determining the time domain attribute label of the image data according to the time domain corresponding to the image data.

14. The method according to claim 1, wherein the target video comprises a video for a commodity promotion scenario.

15. The method according to claim 14, wherein the type of the target video comprises at least one of: a clothing type, a food type, or a cosmetics type.

16. The method according to claim 1, wherein the parameter data further comprises a customized weight parameter group.

17. The method according to claim 1, wherein the parameter data further comprises a type parameter used for indicating the type of the target video.

18. An apparatus for generating a synopsis video, the apparatus comprising:
a memory configured to store instructions; and
one or more processors configured to execute the instructions to cause the apparatus to perform:
acquiring a target video and parameter data related to editing of the target video, wherein the parameter data comprises at least a duration parameter of a synopsis video of the target video;
extracting a plurality of pieces of image data from the target video, and determining an image label of each piece of the plurality of pieces of the image data, wherein the image label comprises at least a visual-type label;
determining a type of the target video;
establishing a target editing model for the target video according to the type of the target video, the duration parameter, and a plurality of preset editing technique submodels; and
editing the target video according to the image label of the image data in the target video by using the target editing model to obtain the synopsis video of the target video.

19. The apparatus according to claim 18, wherein the one or more processors are further configured to execute the instructions to cause the apparatus to perform:
determining, from weight parameter groups of a plurality of groups of preset editing technique submodels according to the type of the target video, a weight parameter group of a preset editing technique submodel matching the type of the target video as a target weight parameter group, where the target weight parameter group comprises preset weights that respectively correspond to the plurality of preset editing technique submodels; and
establishing the target editing model for the target video according to the target weight parameter group, the duration parameter, and the plurality of preset editing technique submodels.

20. A non-transitory computer-readable storage medium storing a set of computer instructions that are executable by one or more processors of an apparatus to cause the apparatus to perform a method comprising:
acquiring a target video and parameter data related to editing of the target video, wherein the parameter data comprises at least a duration parameter of a synopsis video of the target video;
extracting a plurality of pieces of image data from the target video, and determining an image label of each piece of the plurality of pieces of the image data, wherein the image label comprises at least a visual-type label;
determining a type of the target video;
establishing a target editing model for the target video according to the type of the target video, the duration parameter, and a plurality of preset editing technique submodels; and
editing the target video according to the image label of the image data in the target video by using the target editing model to obtain the synopsis video of the target video.
